(19) United States
(12) Patent Application Publication
(10) Pub. No.: US 2018/0372864 A1
(43) Pub. Date: Dec. 27, 2018

(54) Method for Broadcasting a User's Location to Vehicle Operators Using Wireless Communication

(71) Applicant: Waynard Schmidt, West Valley, UT (US)

(72) Inventor: Waynard Schmidt, West Valley, UT (US)

(21) Appl. No.: 15/721,302

(22) Filed: Sep. 29, 2017

Related U.S. Application Data
(60) Provisional application No. 62/522,993, filed on Jun. 21, 2017.

(51) Int. Cl. G01S 13/93; G08G 1/0967; G08G 1/16; B60W 50/14; G01S 5/00

(52) U.S. Cl. CPC G01S 13/931; G08G 1/096791; G08G 1/161; B60W 2550/308; G01S 5/0027; G01S 2013/936; B60W 50/14

(57) ABSTRACT

A method for broadcasting a user's location to vehicle operators using wireless communication makes use of a system that includes a portable beacon and multiple vehicles. The portable beacon is a mobile transmitter that broadcasts a desired message. Each of the vehicles is equipped with a wireless receiver and an alert device. The wireless receiver is capable of deciphering the broadcast from the portable beacon. The alert device is used to alert the operator of a vehicle that there is a nearby pedestrian. The method is initiated by prompting the user to activate the primary proximity alert message with the portable beacon. The portable beacon, then continuously broadcasts the alert message. The alert message is subsequently received by the wireless receiver. Finally, the alert message is output to the operator of a vehicle that is located within a predefined distance from the portable beacon.

The current application claims a priority to the U.S. Provisional Patent application Ser. No. 62/522,993 filed on Jun. 21, 2017.

### FIELD OF THE INVENTION

The present invention relates generally to a safety device that transmits alerts to vehicles. More specifically, the present invention relates to a safety device that wirelessly transmits multiple proximity alert messages to nearby vehicles; thus, alerting the vehicle operator of the proximity to a pedestrian.

### BACKGROUND OF THE INVENTION

The field of the invention is generally that of a safety device capable of transmitting a radio signal with a message that alerts drivers of nearby safety device users. The safety device user may be a pedestrian, a motorcyclist, a bicyclist, a watercraft operator or a different type of vehicle driver. More particularly, the present invention pertains to a safety device that is intended to solve the prior art problem of providing an alert to a driver of a first vehicle, immediate awareness of the presence of a nearby second vehicle or person. This lowers any additional risks of potential accidents due to a driver's unawareness of the ever-changing surroundings. In one instance, a first vehicle driver may have the windows closed and/or have entertainment equipment within said first vehicle operating at a loud volume. The said second vehicle such as a smaller motorcycle or emergency vehicle might be urgently travelling and approaching the first vehicle at a fast speed. In the case that said second vehicle produces a siren for its reserved purpose, the first driver may not be able to hear the siren due to the loud volume output from the first driver's entertainment system and the closed windows. This could be an incredibly dangerous situation in that the second vehicle that is producing the siren may be traveling at a very rapid speed, expecting other vehicles to comply according to the siren being produced. In the case that the first vehicle driver does not respond to the siren due to his inability to hear the second vehicle's siren, the second vehicle could cause a collision with the first vehicle which could lead to additional harm or death of associated people. This safety device would provide an alert via the radio to the first vehicle when the second vehicle is detected within its predetermined proximity. If the first vehicle driver is immediately notified of the presence of the fast approaching second vehicle from within the first driver's own radio, the first vehicle driver will be able to adjust said person's driving accordingly such as pulling over or changing lanes for the second vehicle to pass.

A driver is expected to check the respective mirrors of the vehicle before changing lanes in order to maintain safe driving conditions for other vehicle drivers and to avoid collisions. But there are a series of factors that may impact how a vehicle driver may react to a motorcyclist. For example, drivers may be unaware of the motorcyclist due to the smaller size of the motorcycle relative to other vehicles. When a motorcyclist is in the position of the vehicle driver's blind spots, collision may occur despite the vehicle driver's efforts in checking the respective vehicle mirrors. Such a collision can cause excessive harm to said persons and other surrounding vehicle drivers. Additionally, motorcyclists tend to travel at a more rapid speed than other vehicle drivers. The response time of a vehicle driver may be too slow relative to the rapid speed in which the motorcyclist may be traveling, which can ultimately lead to a collision.

The present invention is an effective solution to the existing issue of accidents due to a driver's unawareness of surroundings. 60% of commuters and recreational boaters listen to either AM or FM radio while driving. The safety device transmits an alert through radios of nearby vehicles. When another vehicle is in near proximity, the person in the vehicle will immediately be alerted through the message presented through the current radio station, prompting the vehicle operator to use additional caution. The vehicle operator will be able to make adjustments necessary to avoid any potential avoidable collisions and accidents. In turn, this safety device will save lives.

Other prior art includes being alerted of other vehicle operators but lack the ability to sense other pedestrians not within a vehicle. Most other prior art contain devices for people who are operating other vehicles with said radio frequencies but do not address the issue with persons who do not have a radio frequency on the person such as a pedestrian crossing the sidewalk or a bicyclist riding in the bike lane. This can pose a hazard to those unsuspecting persons and to the vehicle driver. Bicyclists may be riding down the bike lane but a vehicle driver may not notice the bicyclist due to a blind spot and cause a collision when making a righthand turn. A pedestrian may be crossing the crosswalk but due to the vehicle driver's inability to notice the pedestrian for a number of reasons such as being too dark at night or the pedestrian being too short, a collision may occur causing harm to both parties. With the use of this safety device, the pedestrian or bicyclist will no longer be at a disadvantage. The pedestrian or bicyclist may wear the safety device on their person or be placed on a magnetic surface. Having the device on the person will allow other vehicles to be alerted of their presence within a predetermined radius.

An objective of the present invention is to transmit an alert in some form such as a siren or a verbal message through a specific frequency band when a vehicle or vessel operator such as a motorcyclist, bicyclist, pedestrian, or watercraft operator is detected. Unlike other prior art relevant to this invention, this safety device can be attached to the person and alert any vehicle within the predetermined proximity. This device can be attached to the person or onto any metal body with the use of the strong magnets imbedded into the casing of this device. In the case of a motorcycle rider who has the device attached to their vehicle, a message is broadcasted such as “CAUTION: MOTORCYCLE RIDER IN CLOSE PROXIMITY.” The broadcasted message can be repeated on all AM and FM frequencies within a 30-foot diameter, until the motorcycle is out of range of the receivers. In the case of a child walking to or from school or elsewhere, the broadcasted message might say “CAUTION: CHILDREN IN CLOSE PROXIMITY.” This broadcasted message on all AM and FM frequencies can be repeated until the child is out of the 30-foot range of the receivers. This example would apply to the bicycle rider, watercraft operator and any other vehicle operators. This device additionally includes wireless data exchanging technology. An example of wireless data exchanging technology may be Bluetooth. The user can use the Bluetooth capability to reprogram accordingly via a mobile app on the user's smart phone. The Bluetooth allows for further customization of the device according to the user's needs. The use of this safety device allows all users to have a safer experience on the road and a means of alerting vehicle drivers of any nearby vehicle operators or pedestrians.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a sub-process for updating the primary proximity alert message through the method of the present invention.

FIG. 4 is a flowchart describing a sub-process for preventing the user from updating the primary proximity alert message while traveling above a maximum allowable speed through the method of the present invention.

FIG. 5 is a flowchart describing a sub-process for broadcasting the secondary proximity alert message with the nearby vehicle using the method of the present invention.

FIG. 6 is a flowchart describing a sub-process for audibly outputting the secondary proximity alert message with the portable beacon using the method of the present invention.

FIG. 7 is a flowchart describing a sub-process for visually outputting the secondary proximity alert message with the portable beacon using the method of the present invention.

FIG. 8 is a flowchart describing a sub-process for audibly outputting the primary proximity alert message with the vehicle speaker using the method of the present invention.

FIG. 9 is a flowchart describing a sub-process for visually outputting the primary proximity alert message with the vehicle display device using the method of the present invention.

FIG. 10 is a flowchart describing a sub-process for broadcasting the primary proximity alert message via radio transmission using the method of the present invention.

FIG. 11 is a flowchart describing a sub-process for sequentially broadcasting the primary proximity alert message via radio transmission using the method of the present invention.

FIG. 12 is a flowchart describing a sub-process for randomly broadcasting the primary proximity alert message via radio transmission using the method of the present invention.

FIG. 13 is a flowchart describing a sub-process for alerting the user that the portable beacon is low on battery power using the method of the present invention.

### DETAIL DESCRIPTIONS OF THE INVENTION

All illustrations of the drawings are for the purpose of describing selected versions of the present invention and are not intended to limit the scope of the present invention.

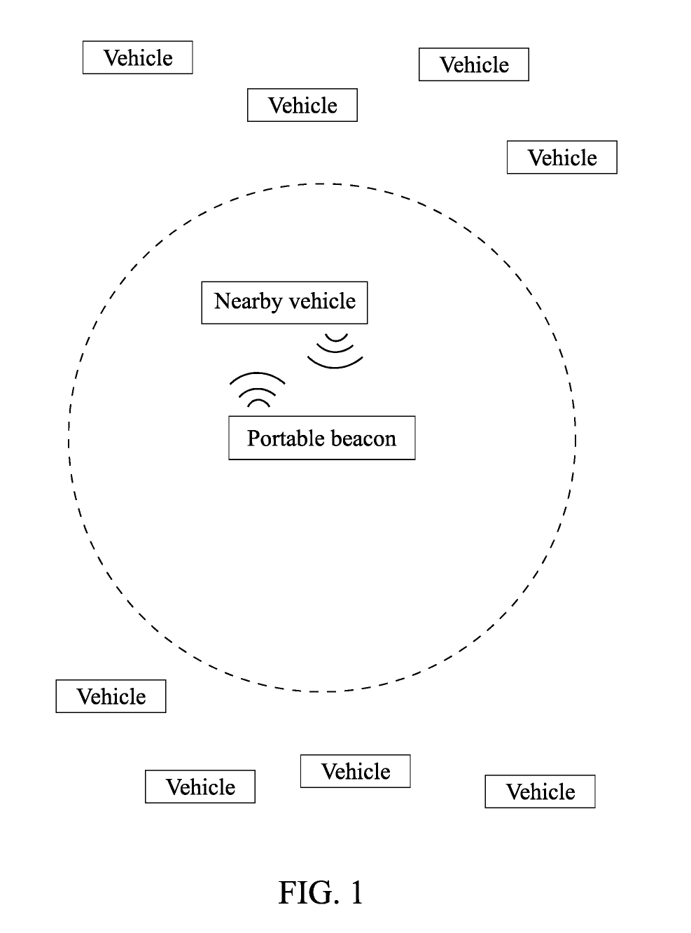

As can be seen in FIG. 1 through FIG. 13, the preferred embodiment of the present invention, the method for broadcasting a user's location to vehicle operators using wireless communication, is a method for improving the safety of vehicle operators, pedestrians, and cyclists. The present invention makes use of a portable beacon device that continuously broadcasts an alert notification to vehicles within a predefined radius. This alert notification is intended to make the operator of a large vehicle or vessel, henceforth simply the operator, aware of their proximity to a user of the portable beacon device who is walking or controlling a smaller vehicle. By alerting the operator, the method of the present invention reduces the chance that an accidental collision will occur between the vehicle operator and the user of the portable beacon device. Specifically, the method of the present invention broadcasts the alert notification over a known radio frequency band. The alert notification is then audibly output to the operator through the vehicle's speakers.

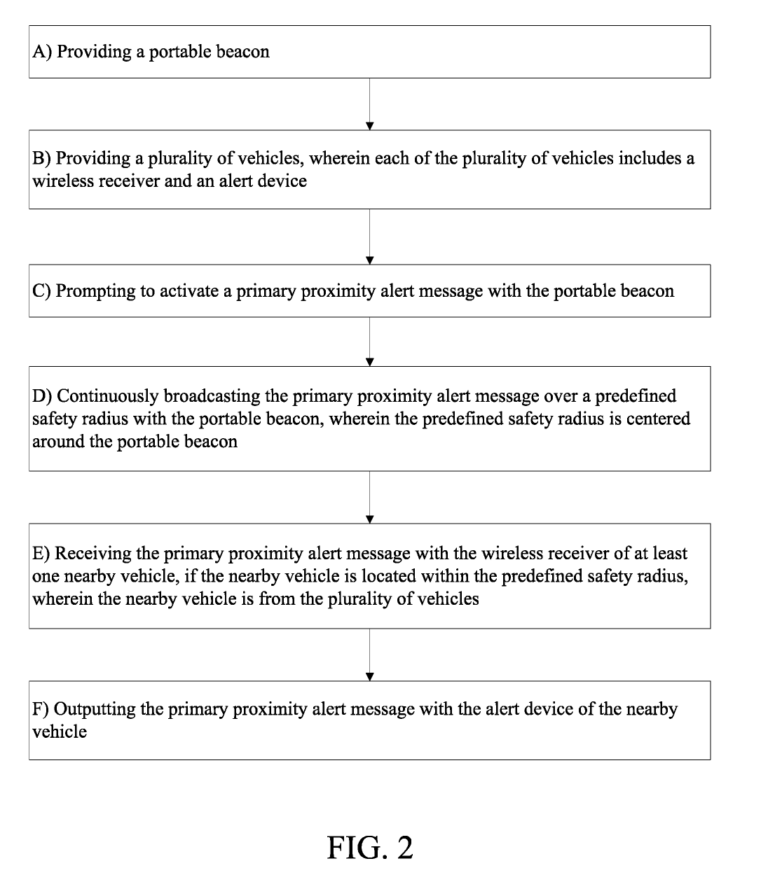

As can be seen in FIG. 1 and FIG. 2, the system required to accomplish the above-described functionality employs two primary components to become operative. First, the system for implementing the method of the present invention provides a portable beacon (Step A). The portable beacon is a device used to transmit and receive wireless communications over a short range. Additionally, the portable beacon can be attached to the user or mounted onto a vehicle carrying the user. Second, the system for implementing the method of the present invention provides a plurality of vehicles (Step B). The plurality of vehicles is made up of other vehicles that are in the area surrounding the user and the portable beacon. These vehicles may include, but are not limited to, cars, trucks, boats, and bikes. Furthermore, each of the plurality of vehicles includes a wireless receiver and an alert device. The wireless receiver and the alert device are preferably the vehicle's radio and speaker system. However, the each of the plurality of vehicles may receive and output the alert notification through various other systems such as, portable computing devices that are equipped with wireless communication units and output devices for instance, speakers or digital displays.

As can be seen in FIG. 1, the overall method of the present invention begins by prompting to activate a primary proximity alert message with the portable beacon (Step C). The primary proximity alert message is a message that the portable beacon transmits to notify the operators of each of the plurality of vehicles that the user is nearby. The first step of the overall method of the present invention begins when the user turns on the portable beacon and directs the portable beacon to begin transmitting the primary proximity alert message. The overall method of the present invention continues by continuously broadcasting the primary proximity alert message over a predefined safety radius with the portable beacon (Step D). The safety radius is a predefined area that is centered around the portable beacon. Additionally, the portable beacon is only capable of broadcasting the primary proximity alert message over the safety radius. This limitation ensures that the operator is only notified of the user's location when the two parties are sufficiently close that an accidental collision is possible. The overall method of the present invention continues by receiving the primary proximity alert message with the wireless receiver of at least one nearby vehicle, if the nearby vehicle is located within the predefined safety radius. The at least one nearby vehicle is from the plurality of vehicles. Specifically, when one or more vehicles enter the safety radius, this vehicle is designated as the at least one nearby vehicle. While the nearby vehicle is within the safety radius, the primary proximity alert message will be transmitted to the wireless receiver. The portable beacon will no longer be able to communicate with the nearby vehicle while the nearby vehicle is not within the safety radius, at which point, the nearby vehicle will be redesignated as one of the plurality of vehicles. The overall method of the present invention continues by outputting the primary proximity alert message with the alert device of the nearby vehicle. Once the primary proximity alert message is received by the wireless receiver of the nearby vehicle, the primary proximity alert message is conveyed to the operator so that the operator becomes aware of the presence of the user. The primary proximity alert message is preferably conveyed to the operator through the sound system of the large vehicle. However, the primary proximity alert message may be visually displayed through the vehicle's dashboard or on a portable computing device.

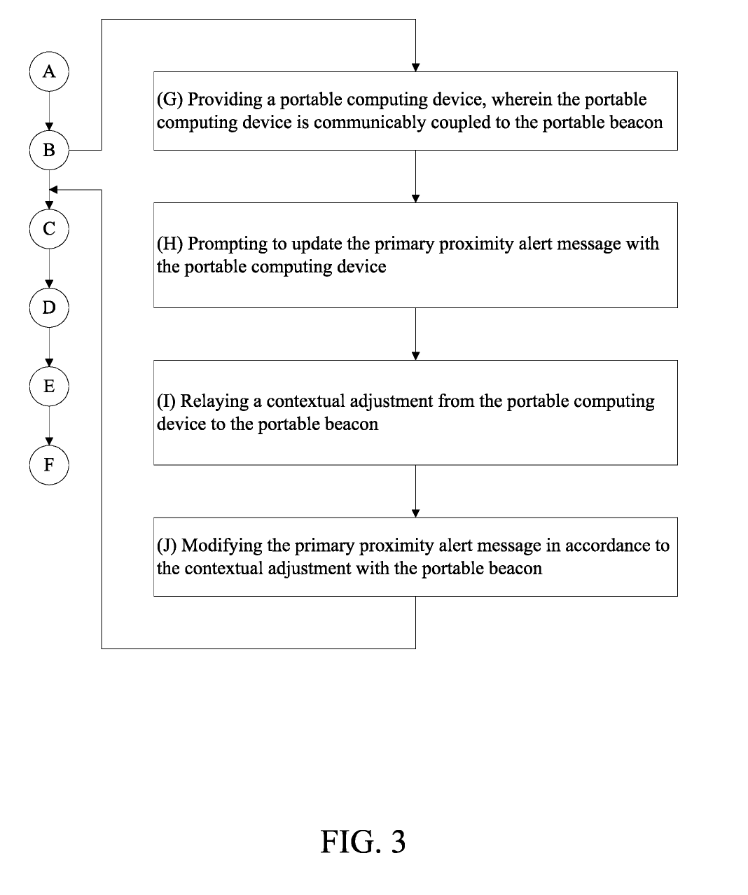

As can be seen in FIG. 3, because the method of the present invention is designed to be used by pedestrians, cyclists, and watercraft pilots, the method of the present invention includes a sub-process that enables the user to change the primary proximity alert message as desired. The sub-process responsible for accomplishing this begins by providing a portable computing device (Step G). The portable computing device is a mobile device capable of running an application that is used to read information from and send commands to the portable beacon. Additionally, the portable computing device is communicably coupled to the portable beacon. As such, the portable computing device is able to wirelessly send information to and receive information from the portable beacon. The portable computing device can be, but is not limited to, a smart phone, a tablet computer, or a GPS unit. The sub-process continues by prompting to update the primary proximity alert message with the portable computing device (Step H). This step presents the user with the option to change the primary proximity alert message that is continuously broadcast by the portable beacon. For example, if the user is going for a walk the primary proximity alert message may be “pedestrian nearby”. After the walk, the user may decide to take a bike ride. At this point, the user is able to update the primary proximity alert message to “cyclist nearby” by choosing the appropriate update option through the portable computing device. Preferably, the user is presented with a list of predefined options for the updated primary proximity alert message. However, the method of the present invention enables the user to create a customized primary proximity alert message as well. The sub-process continues by relaying a contextual adjustment from the portable computing device to the portable beacon (Step I). The contextual adjustment is the update that was selected by the user which will be integrated into primary proximity alert message. This step is executed by transmitting the contextual adjustment to the portable beacon. The sub-process continues by modifying the primary proximity alert message in accordance to the contextual adjustment with the portable beacon. Once the portable beacon receives the contextual adjustment, the primary proximity alert message is reworded to include the contextual update. The newly reworded primary proximity alert message is then broadcasted by the portable beacon.

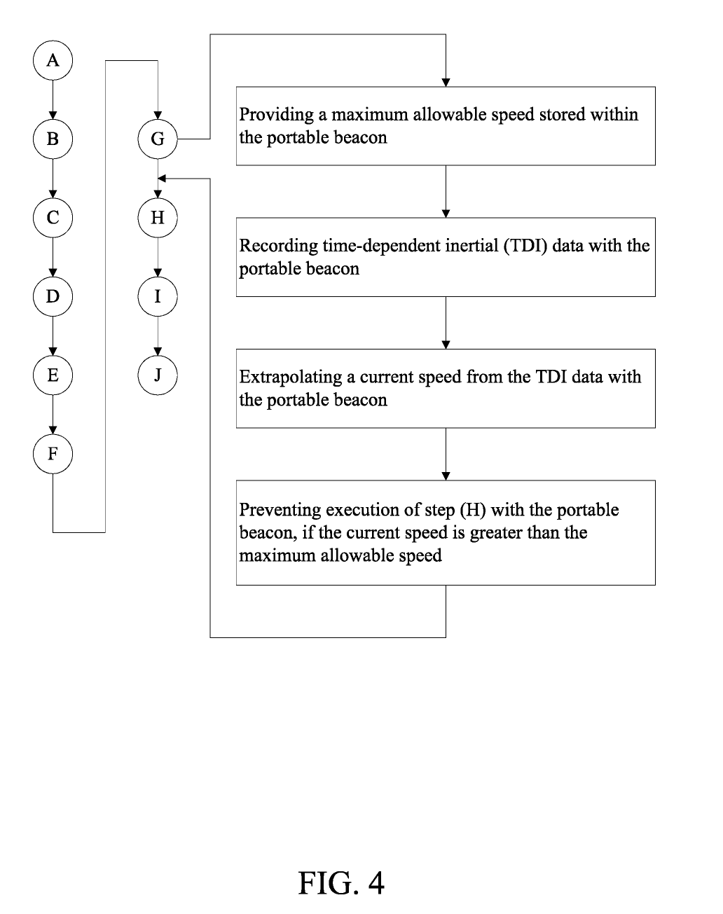

As can be seen in FIG. 4, the method of the present invention is designed to increase the safety of users and operators. To accomplish this, the method of the present invention is designed to prevent the user from updating the primary proximity message while moving at high speeds which exceed a preset threshold. This provision prevents the user from multitasking while driving. To accomplish this, the sub-process begins by providing a maximum allowable speed stored within the portable beacon. The maximum allowable speed is the speed threshold beyond which the user cannot modify the primary proximity alert message. The sub-process continues by recording time-dependent inertial (TDI) data with the portable beacon. The TDI data contains information about the portable beacon's current velocity and heading. This data is used to extrapolate a current speed from the TDI data with the portable beacon. Once the current speed is determined, the sub-process continues by preventing execution of Step H with the portable beacon, if the current speed is greater than the maximum allowable speed. Thus, the sub-process prevents the user from becoming a distracted driver.

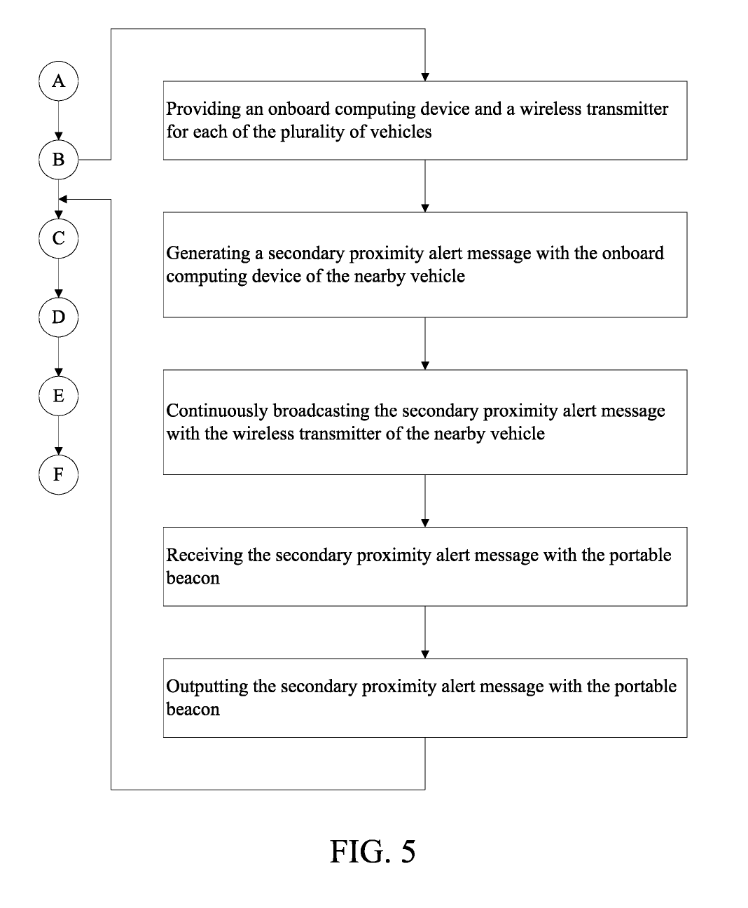

As can be seen in FIG. 5, the method of the present invention further increases safety by including a sub-process which allows the plurality of vehicles to broadcast a proximity alert to the portable beacon. This proximity alert is intended to make the user aware of the nearby vehicle, if the user is not paying attention. To accomplish this, the sub-process begins by providing an onboard computing device and a wireless transmitter for each of the plurality of vehicles. Preferably, the onboard computing device is an electronic device that is integrated into each of the plurality of vehicles. Furthermore, the wireless transmitter is electronically coupled to the onboard computing device so that the onboard computing device is able to transmit the proximity alert. The sub-process continues by generating a secondary proximity alert message with the onboard computing device of the nearby vehicle. The secondary proximity alert message is the proximity alert that the onboard computing device transmits to the portable beacon. The sub-process continues by continuously broadcasting the secondary proximity alert message with the wireless transmitter of the nearby vehicle. This enables the operator to alert the user that a large vehicle is nearby. The sub-process continues by receiving the secondary proximity alert message with the portable beacon. Finally, the sub-process concludes by outputting the secondary proximity alert message with the portable beacon. As a result, the user is notified of the nearby vehicle's proximity and is thus more able to prevent an accidental collision.

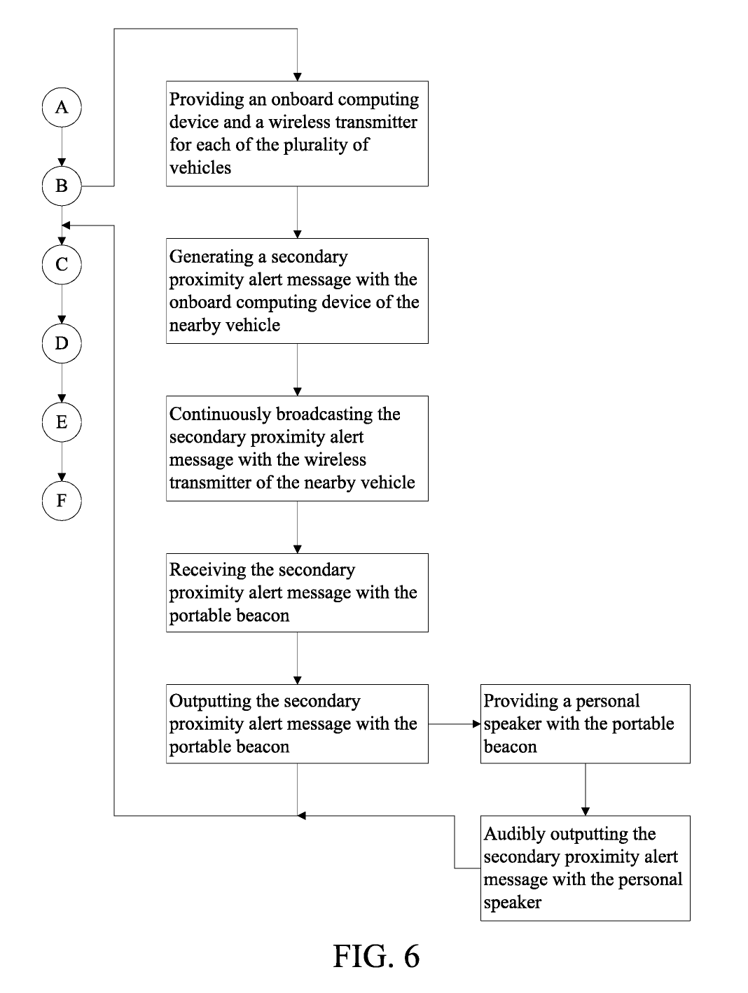

As can be seen in FIG. 6, in a first alternative embodiment of the method of the present invention, a personal speaker is provided with the portable beacon. As such, the sub-process concludes by audibly outputting the secondary proximity alert message with the personal speaker. In a second alternative embodiment of the method of the present invention, a personal display device is provided with the portable beacon. As such, the sub-process concludes by visually outputting the secondary proximity alert message with the personal display device.

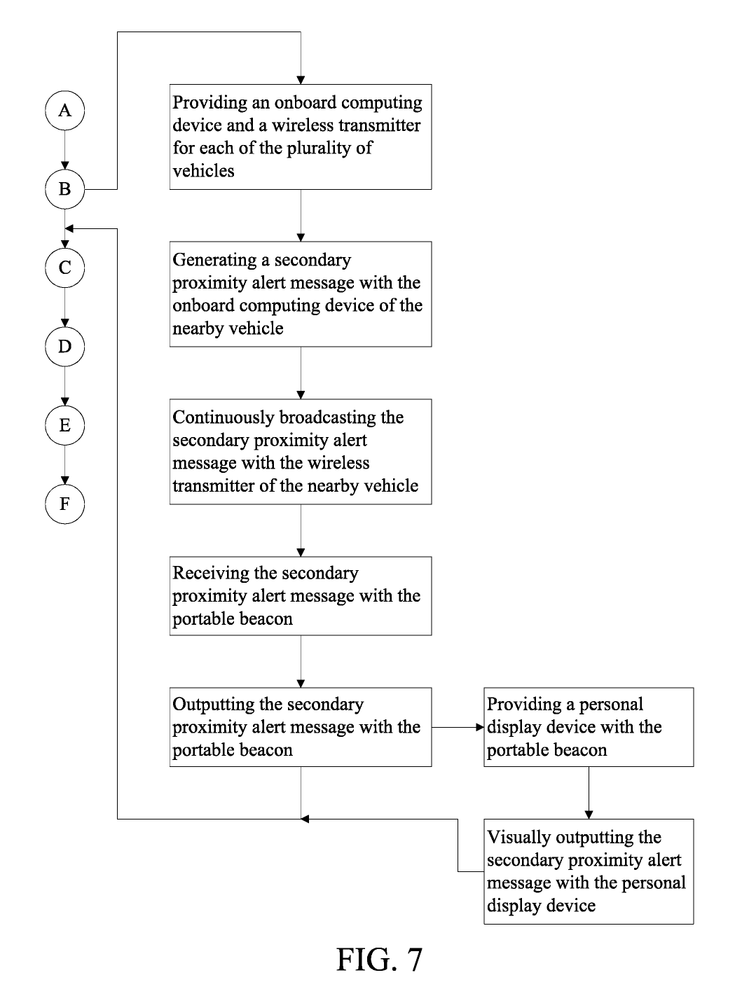

As can be seen in FIG. 7, in the first alternative embodiment of the method of the present invention, a vehicle speaker is provided for each of the plurality of vehicles. As such, the overall method of the present invention concludes by audibly outputting the primary proximity alert message with the vehicle speaker. In the second alternative embodiment of the method of the present invention, a vehicle display device is provided for each of the plurality of vehicles. Accordingly, the overall method of the present invention concludes by visually outputting the primary proximity alert message with the vehicle display device.

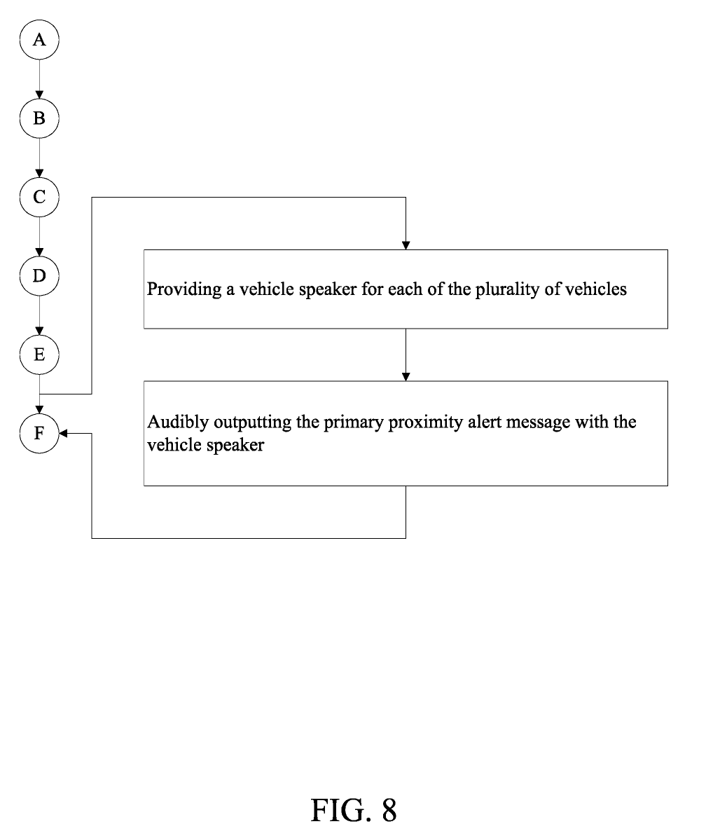

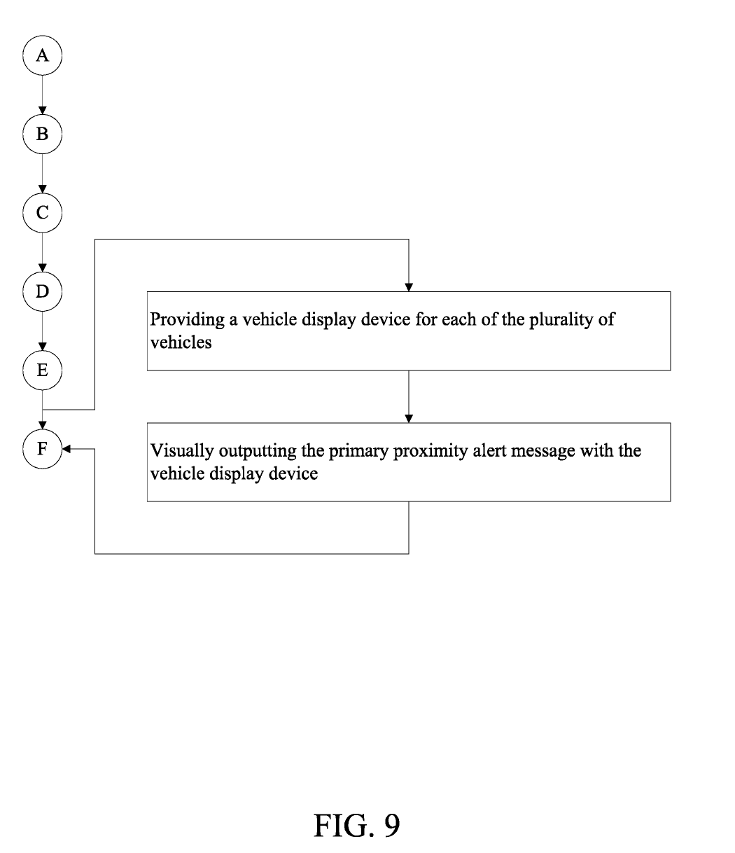

As can be seen in FIG. 8 and FIG. 9, the method of the present invention preferably relays proximity alerts between the portable beacon and the plurality of vehicles through radio communication. As such, the portable beacon is equipped with a radio transmitter. Relatedly, the wireless receiver for each of the plurality of vehicles is a radio receiver. The radio transmitter is a device used to broadcast information via amplitude modulation (AM) and frequency modulation (FM) protocols. Likewise, the radio receiver is a device used to decipher information that is broadcast using AM and FM protocols. This enables the present invention to overlay the primary proximity alert message over the music that is being played on the radio of the nearby vehicle. Consequently, the overall method of the present invention is accomplished by broadcasting the primary proximity alert message during Step D as a radio signal with the radio transmitter. Furthermore, the overall method of the present invention is accomplished by receiving the radio signal during Step E as the primary proximity alert message with the radio receiver of the nearby vehicle. Thus, the method of the present invention is able to transmit the primary proximity alert message over the most widely implemented format for broadcasted information.

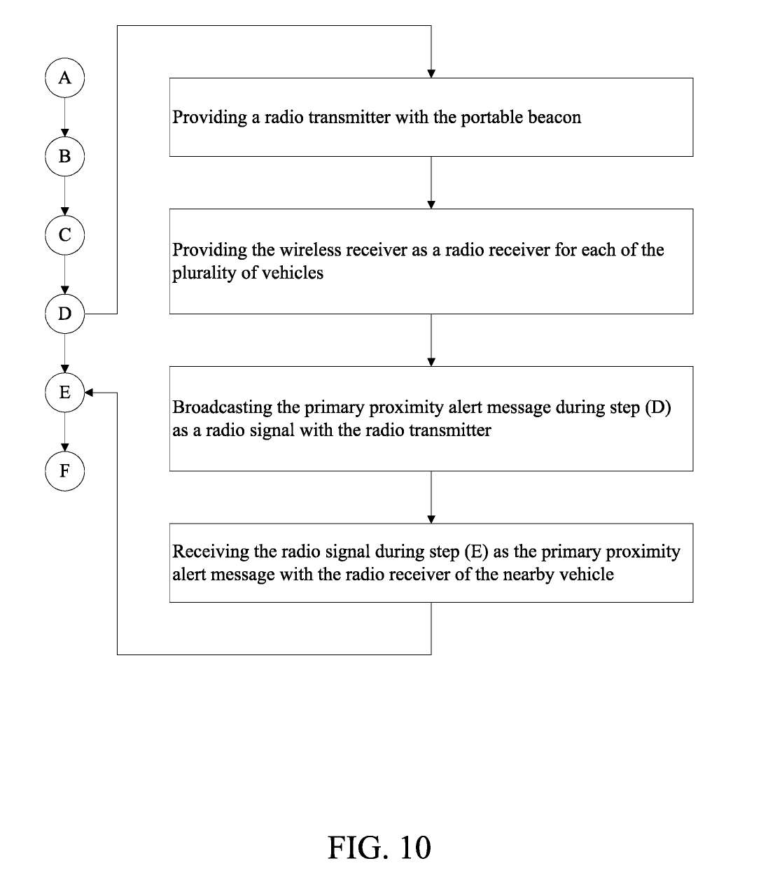

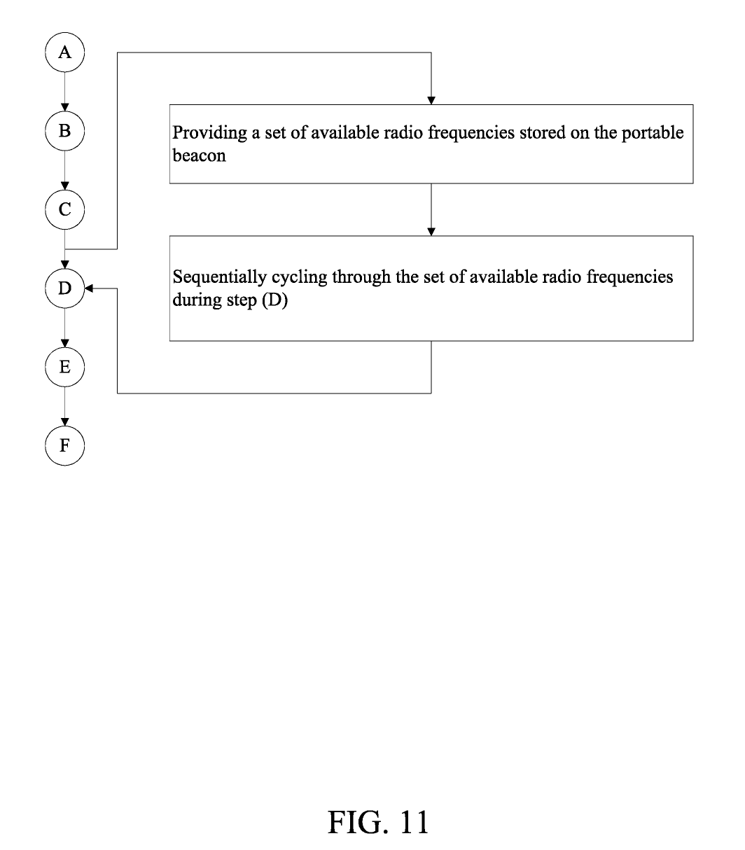

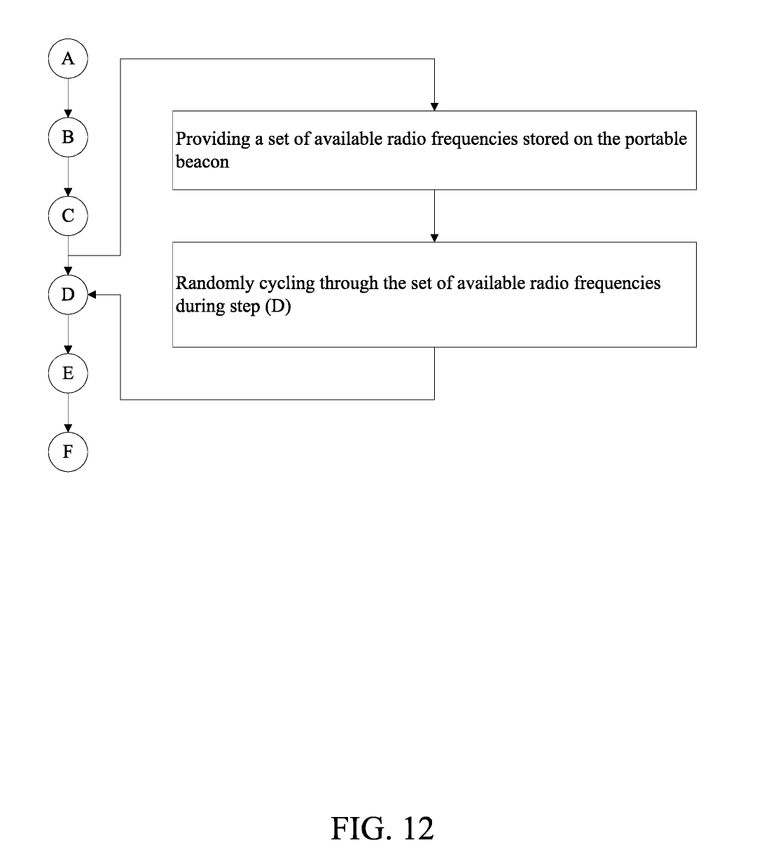

As can be seen in FIG. 10, FIG. 11, and FIG. 12, in the overall method of the present invention, once the portable beacon is activated, a warning message is broadcasted in a 30-foot diameter range using the 86 MHz to 92 MHz frequency band for AM and FM radio receivers. To accomplish this, the method of the present invention provides a set of available radio frequencies that is stored on the portable beacon. Additionally, the present invention is designed with two distinct sub-processes for broadcasting the primary proximity alert message to the nearby vehicle. These sub-processes increase the likelihood that the operator will be alerted to the presence of a nearby user. The first sub-process involves sequentially cycling through the set of available radio frequencies during Step D. Alternatively, the second sub-process involves randomly cycling through the set of available radio frequencies during Step D. By cycling through the set of available radio frequencies, the method of the present invention is able to increase the chance that the primary proximity alert message will be played over the radio station that the operator is listening to.

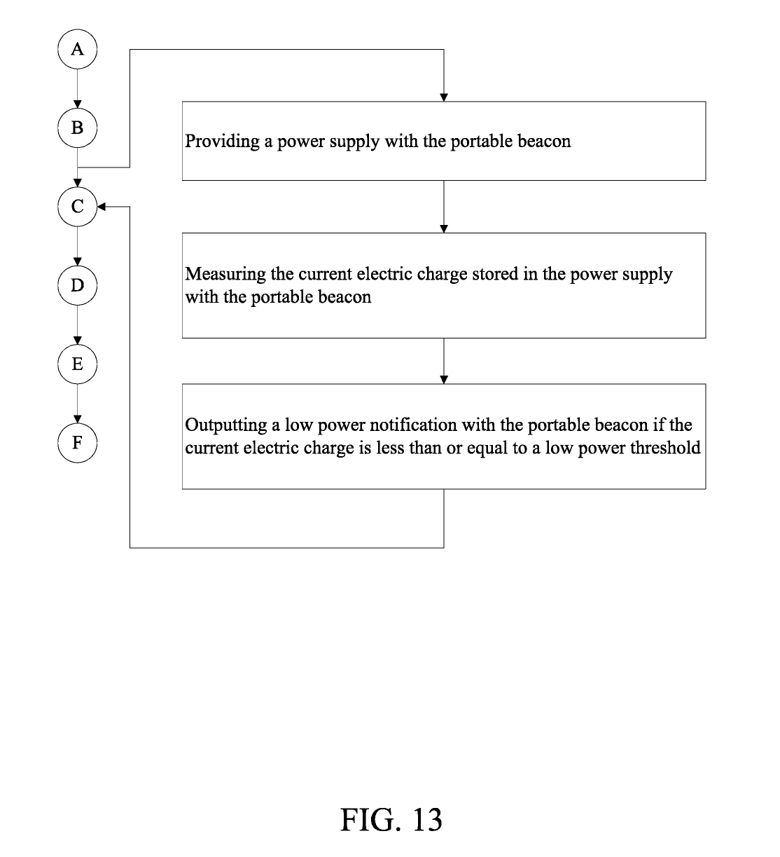

As can be seen in FIG. 13, finally, the overall method of the present invention includes a sub-process for checking the amount of charge stored in an onboard battery. Accordingly, this sub-process begins by providing a power supply with the portable beacon. The sub-process continues by measuring the current electric charge stored in the power supply with the portable beacon. This step enables the portable beacon to determine how much charge is remaining in the power supply. Finally, the sub-process concludes by outputting a low power notification with the portable beacon if the current electric charge is less than or equal to a low power threshold. Consequently, the user is kept abreast of the remaining electrical charge and is able to act accordingly.

Although the invention has been explained in relation to its preferred embodiment, it is to be understood that many other possible modifications and variations can be made without departing from the spirit and scope of the invention as hereinafter claimed.

What is claimed is:

1. A method for broadcasting a user's location to vehicle operators using wireless communication comprises:
(A) providing a portable beacon;
(B) providing a plurality of vehicles, wherein each of the plurality of vehicles includes a wireless receiver and an alert device;
(C) prompting to activate a primary proximity alert message with the portable beacon;
(D) continuously broadcasting the primary proximity alert message over a predefined safety radius with the portable beacon, wherein the predefined safety radius is centered around the portable beacon;
(E) receiving the primary proximity alert message with the wireless receiver of at least one nearby vehicle, if the nearby vehicle is located within the predefined safety radius, wherein the nearby vehicle is from the plurality of vehicles;
(F) outputting the primary proximity alert message with the alert device of the nearby vehicle;

2. The method for broadcasting a user's location to vehicle operators using wireless communication as claimed in claim 1 comprises:
(G) providing a portable computing device, wherein the portable computing device is communicably coupled to the portable beacon;
(H) prompting to update the primary proximity alert message with the portable computing device;
(I) relaying a contextual adjustment from the portable computing device to the portable beacon;
(J) modifying the primary proximity alert message in accordance to the contextual adjustment with the portable beacon;

3. The method for broadcasting a user's location to vehicle operators using wireless communication as claimed in claim 2 comprises:
providing a maximum allowable speed stored within the portable beacon;
recording time-dependent inertial (TDI) data with the portable beacon;
extrapolating a current speed from the TDI data with the portable beacon;
preventing execution of step (H) with the portable beacon, if the current speed is greater than the maximum allowable speed;

4. The method for broadcasting a user's location to vehicle operators using wireless communication as claimed in claim 1 comprises:
providing an onboard computing device and a wireless transmitter for each of the plurality of vehicles;
generating a secondary proximity alert message with the onboard computing device of the nearby vehicle;
continuously broadcasting the secondary proximity alert message with the wireless transmitter of the nearby vehicle;
receiving the secondary proximity alert message with the portable beacon;
outputting the secondary proximity alert message with the portable beacon;

5. The method for broadcasting a user's location to vehicle operators using wireless communication as claimed in claim 4 comprises:
providing a personal speaker with the portable beacon;
audibly outputting the secondary proximity alert message with the personal speaker;

6. The method for broadcasting a user's location to vehicle operators using wireless communication as claimed in claim 4 comprises:
providing a personal display device with the portable beacon;
visually outputting the secondary proximity alert message with the personal display device;

7. The method for broadcasting a user's location to vehicle operators using wireless communication as claimed in claim 1 comprises:
providing a vehicle speaker for each of the plurality of vehicles;
audibly outputting the primary proximity alert message with the vehicle speaker;

8. The method for broadcasting a user's location to vehicle operators using wireless communication as claimed in claim 1 comprises:
providing a vehicle display device for each of the plurality of vehicles;
visually outputting the primary proximity alert message with the vehicle display device;

9. The method for broadcasting a user's location to vehicle operators using wireless communication as claimed in claim 1 comprises:
providing a radio transmitter with the portable beacon;
providing the wireless receiver as a radio receiver for each of the plurality of vehicles;
broadcasting the primary proximity alert message during step (D) as a radio signal with the radio transmitter;
receiving the radio signal during step (E) as the primary proximity alert message with the radio receiver of the nearby vehicle;

10. The method for broadcasting a user's location to vehicle operators using wireless communication as claimed in claim 1 comprises:
providing a set of available radio frequencies;
sequentially cycling through the set of available radio frequencies during step (D);

11. The method for broadcasting a user's location to vehicle operators using wireless communication as claimed in claim 1 comprises:
providing a set of available radio frequencies stored on the portable beacon;
randomly cycling through the set of available radio frequencies during step (D);

12. The method for broadcasting a user's location to vehicle operators using wireless communication as claimed in claim 1 comprises:
providing a power supply with the portable beacon;
measuring the current electric charge stored in the power supply with the portable beacon;
outputting a low power notification with the portable beacon if the current electric charge is less than or equal to a low power threshold;
